(19) United States
(12) Patent Application Publication
(10) Pub. No.: US 2026/0296289 A1
(43) Pub. Date: Oct. 1, 2026

(54) FLOOR CARPET AND VEHICLE INCLUDING THE SAME

(71) Applicants: Hyundai Motor Company, Seoul (KR); Kia Corporation, Seoul (KR); Dong Jin Industrial Co., LTD., Gyeongju-si (KR)

(72) Inventors: Tae Oh MOON, Hwaseong-si (KR); Byung Yong CHOI, Hwaseong-si (KR); Dong Wook LEE, Hwaseong-si (KR); Won Young NA, Hwaseong-si (KR); Bo Hak SEO, Gyeongju-si (KR); Sang Hyuk LEE, Pohang-si (KR)

(21) Appl. No.: 19/304,305

(22) Filed: Aug. 19, 2025

(30) Foreign Application Priority Data
Mar. 31, 2025 (KR) 10-2025-0041573

(51) Int. Cl. B60N 3/04; B60H 1/00

(52) U.S. Cl. CPC B60N 3/048; B60H 1/00021; B60H 1/00207; B60H 1/00564; B60N 3/046; B60H 2001/00185; B60H 2001/00221

(57) ABSTRACT

A floor carpet apparatus includes a floor carpet disposed on a floor surface in a vehicle cabin, an internal core that is arranged at a bottom surface of the floor carpet and defines a plurality of air pockets, an air duct is integrated with the internal core and defines an air passage configured to guide air, a connection duct that connects the internal core and the air duct to each other, wherein the internal core, the connection duct, and the air duct are arranged on a common plane, and a body that surrounds the internal core, the connection duct, and the air duct, the body being configured to support the internal core, the connection duct, and the air duct.

### CROSS-REFERENCE TO RELATED APPLICATION

This application claims, under 35 U.S.C. § 119(a), the benefit of and priority to Korean Patent Application No. 10-2025-0041573, filed on Mar. 31, 2025, the entire contents of which are incorporated herein by reference.

### TECHNICAL FIELD

The present disclosure relates to a floor carpet and a vehicle including the same. More particularly, the present disclosure relates to a floor carpet and a vehicle including the same, where the floor carpet includes an air duct integrated with an injected core configured to absorb noise, improving space utilization and air conditioning performance.

### BACKGROUND

A vehicle may include a noise absorber at various locations in the vehicle, such as in a dash panel configured to partition a vehicle cabin from an engine room to block noise generated in the engine room, and in a floor panel to block noise transmitted from a vehicle floor.

In some cases, the noise absorber employed in the floor panel may be provided for the purpose of blocking noise by being mounted on a bottom surface of a floor carpet and for the purpose of supporting the floor carpet.

For instance, the floor carpet may be mounted on a floor surface in a vehicle cabin to prevent a driver or passengers from slipping, to drain rainwater, to prevent dirt or dust on shoes, etc., from sticking to the floor carpet, and to perform noise-absorbing performance.

In some cases, the noise absorber may be employed for the purpose of blocking noise generated from an engine and introduced through the vehicle body and noise generated when tires contact the road surface and introduced through the vehicle body, and for the purpose of reinforcing the support rigidity of the floor carpet. The noise absorber may have a structure formed by, for example, applying polyurethane (PU) foam onto an expanded polypropylene (EPP) pad.

In some cases, a floor air duct may be mounted, together with the noise absorber, on the bottom surface of the floor carpet, where the floor air duct has a structure, which is separated from the noise absorber.

In some cases, due to the floor air duct separated from the noise absorber and the structural characteristics of the noise absorber, space restrictions may exist in terms of layout, which may decrease performance and marketability of the floor air duct.

### SUMMARY

The present disclosure describes a floor carpet and a vehicle including the same, where the floor carpet includes an injected core configured to absorb noise and an air duct through which air flows. The injected core and the air duct are integrated into a single structure and provided on a bottom surface of the floor carpet through polyurethane foaming, making it easier to utilize a space in the layout while increasing the effect of improving air conditioning performance.

According to one aspect of the subject matter described in this application, a floor carpet apparatus includes an internal core that defines a plurality of air pockets, an air duct arranged at a side of the internal core and connected to the internal core, the air duct defining an air passage configured to guide air, a connection duct that connects the internal core and the air duct to each other, where the internal core, the connection duct, and the air duct are arranged on a common plane, and a body that surrounds the internal core, the connection duct, and the air duct, the body being configured to support the internal core, the connection duct, and the air duct.

Implementations according to this aspect can include one or more of the following features. For example, the internal core can further define a plurality of noise inlet holes, each of the plurality of noise inlet holes being downwardly open from a corresponding one of the plurality of air pockets. In some examples, the body can define a plurality of through-holes that are in fluid communication with the plurality of noise inlet holes, respectively, where each of the plurality of through-holes is defined at a position corresponding to one of the plurality of noise inlet holes and connects the one of the plurality of noise inlet holes to an outside of the body.

In some implementations, the floor carpet apparatus can further include a door configured to define a side wall of the air duct and to selectively open the side wall to thereby allow air to flow from the air passage into the plurality of air pockets. For example, the door can include a gate configured to partition the internal core and the air duct from each other, a first gear connected to the gate and rotatably coupled to the gate, and a second gear meshed with the first gear and configured to selectively rotate the first gear to thereby open the side wall of the air duct.

In some examples, the connection duct defines a catch groove that is configured to, based on rotation of the door relative to the air duct, catch the door and to release the door, and where the door is configured to be released from the catch groove based on the door rotating in a direction to open the side wall of the air duct. In some examples, the internal core can further define a plurality of air ventilation holes, each of the plurality of air ventilation holes being upwardly open from a corresponding one of the plurality of air pockets.

In some examples, the floor carpet apparatus can further include a floor carpet that is disposed above the body and defines a plurality of air discharge holes, where each of the plurality of air ventilation holes is in fluid communication with a corresponding one of the plurality of air discharge holes defined in the floor carpet. In some implementations, the air duct can be integrated with the internal core through blow molding.

In some examples, the floor carpet apparatus can further include a floor carpet that is disposed above the body, where the body is made from polyurethane (PU) foam and is configured to fix the internal core and the air duct on a bottom surface of the floor carpet. In some examples, the internal core, the connection duct, and the air duct are integrated with one another through blow molding.

According to another aspect, a vehicle include a floor carpet disposed on a floor surface in a vehicle cabin of the vehicle, an internal core that is arranged at a bottom surface of the floor carpet and defines a plurality of air pockets, an air duct arranged at a side of the internal core and connected to the internal core, the air duct defining an air passage configured to guide air, a connection duct that connects the internal core and the air duct to each other, where the internal core, the connection duct, and the air duct are arranged on a common plane, and a body that surrounds the internal core, the connection duct, and the air duct, the body being configured to support the internal core, the connection duct, and the air duct.

Implementations according to this aspect can include one or more of the features described above with respect to the floor carpet apparatus.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to various embodiments thereof illustrated in the accompanying drawings which are given herein below by way of illustration only, and thus are not limitative of the present disclosure.

FIG. 1 is a view illustrating an example of a floor carpet apparatus.

FIG. 2 is a view illustrating an example of an internal core and an air duct for the floor carpet apparatus.

FIG. 3 is an A-A cross-sectional view of FIG. 1.

FIG. 4A is a view illustrating an example of an internal core for the floor carpet apparatus.

FIG. 4B is a B-B cross-sectional view of FIG. 4a.

FIG. 5 is a view illustrating an example of an internal core and a body for the floor carpet apparatus.

FIG. 6 is a view illustrating an example of a door for the floor carpet apparatus.

FIG. 7 is a C-C cross-sectional view of FIG. 6.

FIG. 8A and FIG. 8B are views illustrating example motions of a gate for the floor carpet apparatus.

FIG. 9 is a view illustrating an example of an air ventilation hole for the floor carpet.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION

Hereinafter, one or more implementations according to the present disclosure will be described in detail with reference to the accompanying drawings. Advantages and features of the present disclosure, and a method of achieving the same, will be apparent with reference to the embodiments described below in detail in conjunction with the accompanying drawings.

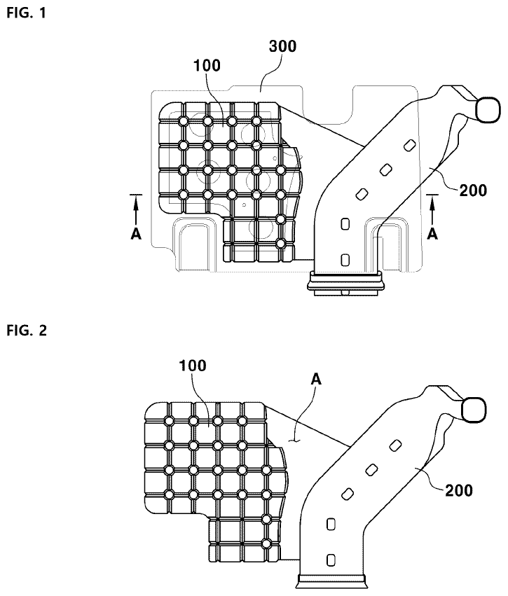

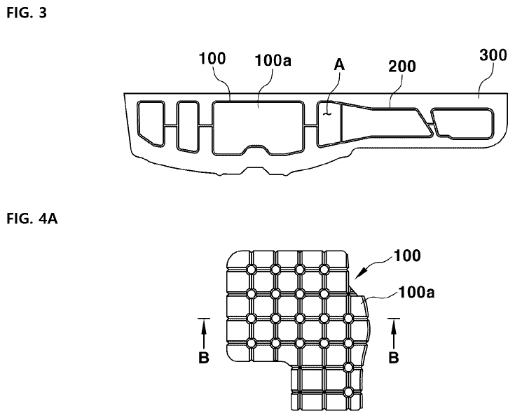

FIG. 1 is a view illustrating an example of a floor carpet apparatus, FIG. 2 is a view illustrating an example of an internal core and an air duct for the floor carpet apparatus, and FIG. 3 is an A-A cross-sectional view of FIG. 1 illustrating a structure for the floor carpet apparatus.

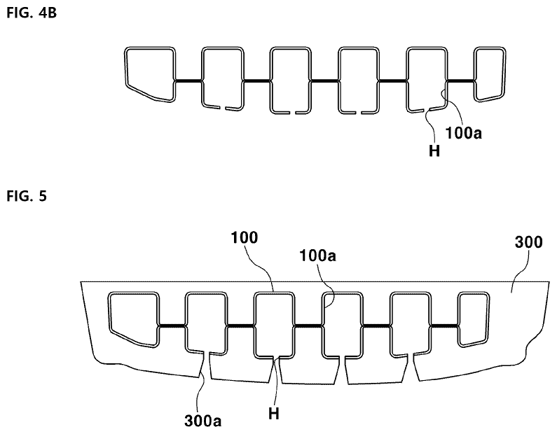

FIG. 4A is a view illustrating an example of an internal core for the floor carpet apparatus, FIG. 4B is a B-B cross-sectional view of FIG. 4A, and FIG. 5 is a view illustrating an example of an internal core and a body for the floor carpet apparatus.

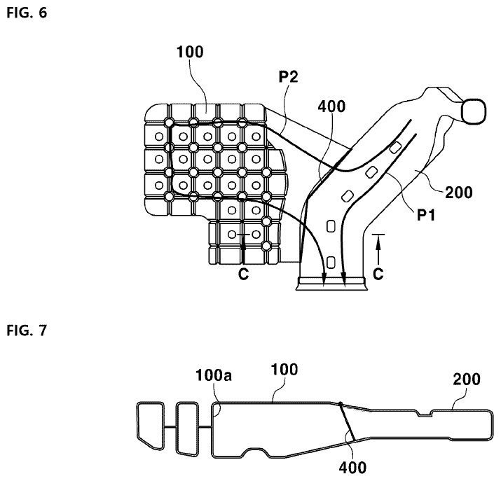

FIG. 6 is a view illustrating an example of a door for the floor carpet apparatus, and FIG. 7 is a C-C cross-sectional view of FIG. 6.

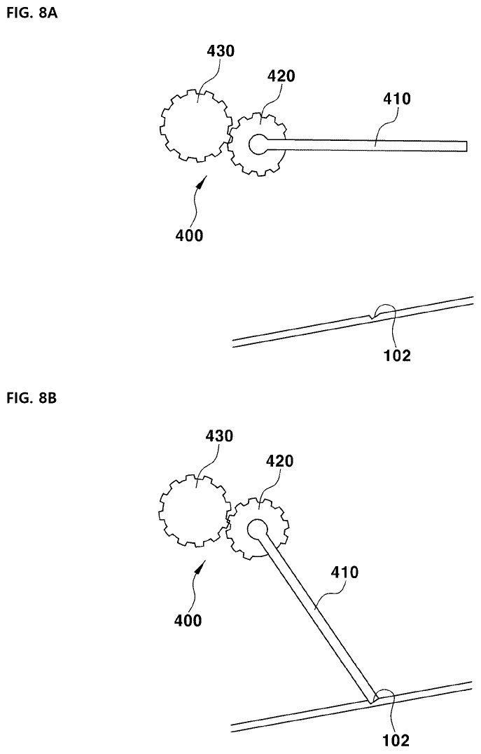

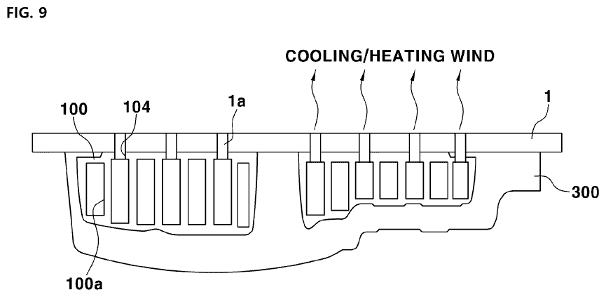

FIG. 8A and FIG. 8B are views illustrating example motions of a gate for the floor carpet apparatus, and FIG. 9 is a view illustrating an example of an air ventilation hole for the floor carpet apparatus.

In some implementations, as illustrated in FIG. 1, a floor carpet apparatus can include a floor carpet 1 (see FIG. 9) that is provided on a floor surface in a vehicle cabin and that includes an internal core 100, an air duct 200, and a body 300. The floor carpet apparatus can include a connection duct A.

In some implementations, the floor carpet apparatus can be mounted in a vehicle cabin for the purpose of blocking and absorbing various noises, such as noise transmitted from the road surface while travelling and engine noise generated during operation, and for the purpose of providing passengers with a sensation of comfortable ride, such as cushioning and heat retention.

The internal core 100 is located at a bottom surface of the floor carpet 1 and has a structure including a plurality of air pockets 100a in a width direction.

The plurality of air pockets 100a can be identical in size, or can be different in size as illustrated in FIG. 3.

The air pockets 100a can serve as a rigid reinforcement material for supporting the floor carpet 1. Moreover, because the inside of the air pockets 100a are empty, the air pockets 100a can also serve to eliminate noise coming from the road surface while travelling.

In other words, as illustrated in FIG. 4A, the internal core 100 includes the plurality of air pockets 100a formed through blow molding. The air pockets 100a each can include a noise inlet hole H as illustrated in FIG. 4B, and noise transmitted from the road surface can be eliminated through the noise inlet hole H.

To this end, the body 300 can have through-holes 300a each formed at a position corresponding to the noise inlet hole H, as illustrated in FIG. 5.

Here, because the through-hole 300a connects the noise inlet hole H to the outside, when the noise transmitted from the road surface is introduced into the air pocket 100a through the noise inlet hole H, the air pocket 100a having formed an empty space inside the air pocket 100a allows the noise to be dispersed in various directions to be eliminated, improving road noise reduction performance.

In some implementations, the air duct 200 is arranged on the same line as, together with a connection duct A, the internal core 100, and an air passage P1 for air being discharged from an air conditioner is formed in the air duct 200. For example, the air duct 200, the connection duct A, and the internal core 100 are arranged on a common plane such as a bottom surface of floor carpet 1. As illustrated in FIG. 2, the air duct 200 is integrated with the internal core 100 through injection molding. In some examples, the air duct 200, the internal core 100, and the connection duct A can be integrated with one another through injection molding.

In related art, an air duct and an internal core may be provided individually from each other and arranged to be separated from each other on a bottom surface of a floor carpet. In such a structure, the air duct is arranged to divert the internal core, thus it can be difficult to utilize a space in terms of the layout.

In some implementations according to the present disclosure, the air duct 200 and the internal core 100 are integrated with each other through blow molding and are fixed to the bottom surface of the floor carpet 1 using the body 300. As such, the floor carpet apparatus may not include or use a separate structure for fixing the air duct 200 and the internal core 100 to the bottom surface of the floor carpet 1. This can reduce the number of components, reducing costs and weights and making it easier to utilize a space in the layout.

The body 300 is, as illustrated in FIG. 3, formed to surround the internal core 100 and the air duct 200 and is configured to support the internal core 100 and the air duct 200 inside the body 300 at the bottom surface of the floor carpet 1. The body 300 can surround the connection duct A.

More specifically, the body 300 can fix the internal core 100 and the air duct 200 integrated with each other to the bottom surface of the floor carpet 1 through polyurethane (PU) foaming.

In some cases, with the above described structure of the body 300 completely enclosing the air duct 200 and the internal core 100, the air passage P1 can be, together with the air duct 200, double-shielded, to thereby reducing cooling and heating loss.

In some implementations, the floor carpet apparatus can further include a door 400, as illustrated in FIG. 6.

The door 400 can be disposed between the internal core 100 and the air duct 200 integrated with each other. More specifically, the door 400 can be configured to define a side wall of the air duct 200.

For example, the door 400 can be a partition wall, as illustrated in FIG. 7. The door 400 can be selectively opened, allowing the fluid flowing through the air passage P1 in the air duct 200 to be branched and introduced into the air pockets 100a through a passage P2.

In some implementations, the door 400 includes a gate 410, a first gear 420, and a second gear 430, as illustrated in FIGS. 8A and 8B.

The gate 410 has a predetermined length to define the side wall of the air duct 200, and is configured to partition the internal core 100 and the air duct 200 from each other.

Moreover, the first gear 420 is connected to the gate 410, has a plurality of gear teeth along the external circumferential surface of the first gear 420, and is mounted to be rotatable in an up-down direction.

Furthermore, the second gear 430 has the same shape as the first gear 420, and meshes with the first gear 420. The second gear 430 is configured to open the side wall of the air duct 200 through the gate 410 by the first gear 420 being selectively rotated.

With the structure of the door 400, when the second gear 430 rotates, as illustrated in FIG. 8A, in one direction in a set air conditioning mode, the first gear 420 rotates in the opposite direction to the second gear 430 to rotate the gate 410, opening the side wall of the air duct 200 so that the air flowing through the air duct 200 can be introduced into the air pocket 100a in the internal core 100 through the air passage P2 (see FIG. 6).

In some examples, when the second gear 430 rotates, as illustrated in FIG. 8B, in another direction in response to the set air conditioning mode being deactivated, the first gear 420 rotates in the opposite direction to the second gear 430 to rotate the gate 410, closing the opened side wall of the air duct 200 as in the initial position so that the air can flow through the air passage P1 only via the air duct 200 (see FIG. 6).

In some examples, when the second gear 430 rotates in the direction of blocking the side wall of the air duct 200 as described above, the gate 410 can be positioned to be caught in a catch groove 102 in the connection duct A to limit the rotational position of the gate 410.

Moreover, the aforementioned set air conditioning mode is a mode selected by the driver, and more specifically, can be set to a mode in which air in the air pocket 100a is discharged into the vehicle cabin through the floor carpet 1.

In other words, as illustrated in FIG. 9, the internal core 100 includes an air ventilation hole 104 formed by being upwardly open from the air pocket 100a, wherein the air ventilation hole 104 is formed to communicate with an air discharge hole 1a formed in the bottom surface of the floor carpet 1. With this structure, when the driver selects the set air conditioning mode, the fluid can flow through the air passage P2 and then be discharged into the vehicle cabin through the air ventilation hole 104 and the air discharge hole 1a.

Accordingly, in response to the set air conditioning mode being selected, the fluid is discharged into the vehicle cabin through the air passage P1 in the air duct 200, and at the same time, the fluid branched from the air passage P1 and flowing through the air passage P2 is also discharged into the vehicle cabin through the floor carpet 1, creating a comfortable environment for the vehicle cabin and increasing cooling and heating performance.

As is apparent from the above description, the present disclosure provides the following effects.

According to the present disclosure, an injected core configured to absorb noise and an air duct through which air flows are integrated into a single structure on a bottom surface of a floor carpet through polyurethane foaming, making it easier to utilize a space in the layout while increasing the effect of improving air conditioning performance.

Moreover, according to the present disclosure, an air pocket structure is employed in the injected core so that noise transmitted to the floor carpet can be eliminated inside the air pocket, improving the performance of road noise reduction.

Furthermore, the present disclosure provides a door to allow the injected core and the air duct to selectively communicate with each other, and provides a ventilation hole in the floor carpet where the injected core is located so that the air flowing through the air duct can be discharged into a vehicle cabin through the ventilation hole when the door is opened, improving the air conditioning performance to create a comfortable indoor environment in a vehicle.

The implementations of the present disclosure have been described with reference to the accompanying drawings. However, those skilled in the art to which the present disclosure pertains will understand that various modifications can be made therefrom, and that all or part of the above-described implementations can be selectively combined. Therefore, the true technical protection scope of the present disclosure should be determined by the technical ideas of the appended claims.

What is claimed is:

1. A floor carpet apparatus, comprising:
an internal core that defines a plurality of air pockets;
an air duct arranged at a side of the internal core and connected to the internal core, the air duct defining an air passage configured to guide air;
a connection duct that connects the internal core and the air duct to each other, wherein the internal core, the connection duct, and the air duct are arranged on a common plane; and
a body that surrounds the internal core, the connection duct, and the air duct, the body being configured to support the internal core, the connection duct, and the air duct.

2. The floor carpet apparatus of claim 1, wherein the internal core further defines a plurality of noise inlet holes, each of the plurality of noise inlet holes being downwardly open from a corresponding one of the plurality of air pockets.

3. The floor carpet apparatus of claim 2, wherein the body defines a plurality of through-holes that are in fluid communication with the plurality of noise inlet holes, respectively, and
wherein each of the plurality of through-holes is defined at a position corresponding to one of the plurality of noise inlet holes and connects the one of the plurality of noise inlet holes to an outside of the body.

4. The floor carpet apparatus of claim 1, further comprising a door configured to define a side wall of the air duct and to selectively open the side wall to thereby allow air to flow from the air passage into the plurality of air pockets.

5. The floor carpet apparatus of claim 4, wherein the door comprises:
a gate configured to partition the internal core and the air duct from each other;
a first gear connected to the gate and rotatably coupled to the gate; and
a second gear meshed with the first gear and configured to selectively rotate the first gear to thereby open the side wall of the air duct.

6. The floor carpet apparatus of claim 4, wherein the connection duct defines a catch groove that is configured to, based on rotation of the door relative to the air duct, catch the door and to release the door, and
wherein the door is configured to be released from the catch groove based on the door rotating in a direction to open the side wall of the air duct.

7. The floor carpet apparatus of claim 1, wherein the internal core further defines a plurality of air ventilation holes, each of the plurality of air ventilation holes being upwardly open from a corresponding one of the plurality of air pockets.

8. The floor carpet apparatus of claim 7, further comprising a floor carpet that is disposed above the body and defines a plurality of air discharge holes,
wherein each of the plurality of air ventilation holes is in fluid communication with a corresponding one of the plurality of air discharge holes defined in the floor carpet.

9. The floor carpet apparatus of claim 1, wherein the air duct is integrated with the internal core through blow molding.

10. The floor carpet apparatus of claim 1, further comprising a floor carpet that is disposed above the body,
wherein the body is made from polyurethane (PU) foam and is configured to fix the internal core and the air duct on a bottom surface of the floor carpet.

11. The floor carpet apparatus of claim 1, wherein the internal core, the connection duct, and the air duct are integrated with one another through blow molding.

12. A vehicle, comprising:
a floor carpet disposed on a floor surface in a vehicle cabin of the vehicle;
an internal core that is arranged at a bottom surface of the floor carpet and defines a plurality of air pockets;
an air duct arranged at a side of the internal core and connected to the internal core, the air duct defining an air passage configured to guide air;
a connection duct that connects the internal core and the air duct to each other, wherein the internal core, the connection duct, and the air duct are arranged on a common plane; and
a body that surrounds the internal core, the connection duct, and the air duct, the body being configured to support the internal core, the connection duct, and the air duct.

13. The vehicle of claim 12, wherein the internal core further defines a plurality of noise inlet holes, each of the plurality of noise inlet holes being downwardly open from a corresponding one of the plurality of air pockets.

14. The vehicle of claim 13, wherein the body defines a plurality of through-holes that are in fluid communication with the plurality of noise inlet holes, respectively, and
wherein each of the plurality of through-holes is defined at a position corresponding to one of the plurality of noise inlet holes and connects the one of the plurality of noise inlet holes to an outside of the body.

15. The vehicle of claim 12, further comprising a door configured to define a side wall of the air duct and to selectively open the side wall to thereby allow air to flow from the air passage into the plurality of air pockets.

16. The vehicle of claim 15, wherein the door comprises:
a gate configured to partition the internal core and the air duct from each other;
a first gear connected to the gate and rotatably coupled to the gate; and
a second gear meshed with the first gear and configured to selectively rotate the first gear to thereby open the side wall of the air duct.

17. The vehicle of claim 15, wherein the connection duct defines a catch groove that is configured to, based on rotation of the door relative to the air duct, catch the door and to release the door, and
wherein the door is configured to be released from the catch groove based on the door rotating in a direction to open the side wall of the air duct.

18. The vehicle of claim 12, wherein the internal core further defines a plurality of air ventilation holes, each of the plurality of air ventilation holes being upwardly open from a corresponding one of the plurality of air pockets.

19. The vehicle of claim 18, wherein the floor carpet defines a plurality of air discharge holes, and
wherein each of the plurality of air ventilation holes is in fluid communication with a corresponding one of the plurality of air discharge holes defined in the floor carpet.

20. The vehicle of claim 12, wherein the body is made from polyurethane (PU) foam and is configured to fix the internal core and the air duct on the bottom surface of the floor carpet.
